(19) United States
(12) Patent Application Publication
(10) Pub. No.: US 2002/0158544 A1
(43) Pub. Date: Oct. 31, 2002

(54) EXTERNAL ROTOR CUP WITH ANNULAR FLANGE EXTENDING THEREFROM

(76) Inventors: Dennis P. Bobay, Ossian, IN (US); Michael W. Henry, Fort Wayne, IN (US); Peter B. Lytle, Fort Wayne, IN (US); Guy Bonner JR., Huntington, IN (US); Glen C. Young, Fort Wayne, IN (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,545

(22) Filed: Apr. 26, 2001

(51) Int. Cl. H02K 1/22; H02K 5/00

(52) U.S. Cl. 310/261; 310/89; 310/91

(57) ABSTRACT

An electric motor includes a rotor cup housing having an annular flange extending circumferentially from a sidewall. The motor further includes a stator including a stator core having a winding thereon and a rotor positioned at least partially around the stator. A rotor shaft is positioned at least partially within the stator.

### BACKGROUND OF INVENTION

This invention relates generally to electric motors and more particularly to rotor cups used with electric motors.

Electric motors that include external rotors are also known as inside out motors, and include magnetic elements mounted on an inner surface of a cup-shaped rotor bell. A stator is located inside a plurality of permanent magnets on the rotor bell. The stator and its supporting structure are shaped to receive a bearing for rotatably mounting a rotor shaft through the stator so that the shaft and rotor bell may rotate relative to the stator. The rotor bell rotates as a result of the magnetic interaction of the permanent magnets and magnetic fields created by energizing windings of the stator.

During motor operation the rotor spins, and if the weight distribution of the rotor is not balanced, unwanted vibration is induced within the motor. Vibration generates vibratory stresses within various motor components. These stresses degrade operating performance of the motor and reduce its useful life. Therefore, a balanced rotor reduces operational vibration and improves motor life. If a part is press-fit onto the rotor cup, the cup must be supported without allowing forces to be transmitted to the motor bearings. If the cup is not properly supported, the bearings may be damaged, thus reducing product lifetime or increasing audible noise. To facilitate balancing the rotor, various types of balancing rings are added to the rotor cups, and these rings provide a place to add or remove material to achieve the desired rotor balance. The rings constitute additional parts which increase the process cost of the product.

Many times magnets are not press-fit into the rotor cup, but rather are fitted to include a gap between the cup and the magnet. The gap is filled with an adhesive. This gap requires additional fixtures to hold the magnet in a desired position concentric to the rotor cup to maintain proper balance. If concentricity is not tightly maintained, balance is sacrificed. At times, the magnet is press-fit into the rotor cup and pushing the magnet into the rotor cup results in the magnet breaking, resulting in higher manufacturing costs.

When press-fitting components onto a rotor cup, the roundness of a rotor cup is difficult to maintain to a tight tolerance and is often accomplished by making multiple strikes on the part during the forming operation or by increasing the thickness of the material. Increasing material thickness and making multiple strikes increase the product cost.

It would be desirable to reduce operational vibration and improve the roundness of stamped rotor cups. It would be further desirable for the rotor cup to have a surface for supporting the rotor cup while a load is attached. It would be still further desirable to provide a smooth surface for lead-in when pressing an item, such as a molded permanent magnet, into the rotor cup.

### SUMMARY OF INVENTION

In an exemplary embodiment of the invention, an electric motor includes a rotor cup assembly including a rotor cup housing having a unitary annular flange. The rotor cup housing further includes a top, a bottom, a circumferential sidewall and a cavity defined by the sidewall and the top. The annular flange is a ring which extends circumferentially from the rotor cup sidewall. The annular flange increases stiffness of the rotor cup. In addition, the annular flange provides a large surface area that allows the removal or addition of material to dynamically or statically balance the rotor. Furthermore, the annular flange provides a smooth-surface for lead-in when pressing an item, such as a molded permanent magnet, into the rotor cup. The integrated annular flange assists in maintaining the shape of the rotor cup and results in improving rotor cup balance. As a result, a cost-effective and reliable external rotor cup is provided.

### BRIEF DESCRIPTION OF DRAWINGS

FIG. 1 is a perspective view of a known rotor cup.

FIG. 2 is a perspective view of a rotor cup with an annular flange in accordance with one embodiment of the present invention.

FIG. 3 is a perspective view of an inside-out motor including the flanged rotor cup shown in FIG. 2.

FIG. 4 is a side view of the motor shown in FIG. 3 in a position to be attached to a load.

FIG. 5 is a perspective view of the rotor cup flange shown in FIG. 2 in a position to receive a magnet.

### DETAILED DESCRIPTION

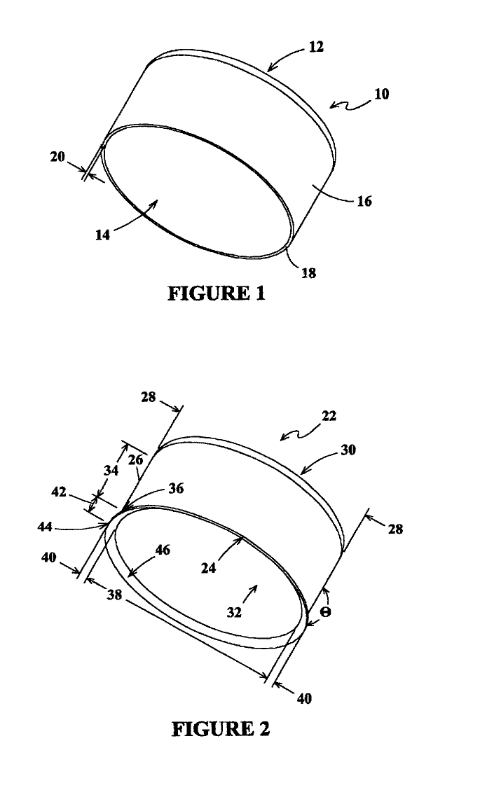

FIG. 1 is a perspective view of a known rotor cup 10 including a closed end 12, an open end 14, and a sidewall 16 extending between open end 14 and closed end 12. Open end 14 is defined by a lower edge 18 of sidewall 16 and includes a substantially uniform circumferential thickness 20.

FIG. 2 is a perspective view of a rotor cup 22 including an annular flange 24. In one embodiment, flange 24 is unitary with rotor cup 22. Rotor cup 22 further includes a circumferential sidewall 26 having a first diameter 28, a top surface 30, and an open bottom 32. Sidewall 26 has a height 34 measured between top surface 30 and a top edge 36 of annular flange 24. Annular flange 24 is fabricated from the same material as rotor cup 22. In one embodiment, annular flange 24 is fabricated from stamped steel. Annular flange 24 is substantially circular in shape and has an inside diameter 28 and an outside diameter 40. Inside diameter 38 is smaller than outside diameter 40. Annular flange 24 has a height 42 measured between a bottom edge 44 and top edge 36. In addition, annular flange 24 is outwardly flared from sidewall 26 by an angle φ measured between sidewall 26 and bottom edge 44. Angle φ permits annular flange 24 to have an outwardly flared curved edge 46 which allows rotor cup 22 to lay flat on a surface (not shown in FIG. 2).

Annular flange 24 increases rotor cup 22 stiffness. In addition, because curved edge 46 is outwardly flared by an angle φ, edge 46 provides additional surface area and strength to support rotor cup 22.

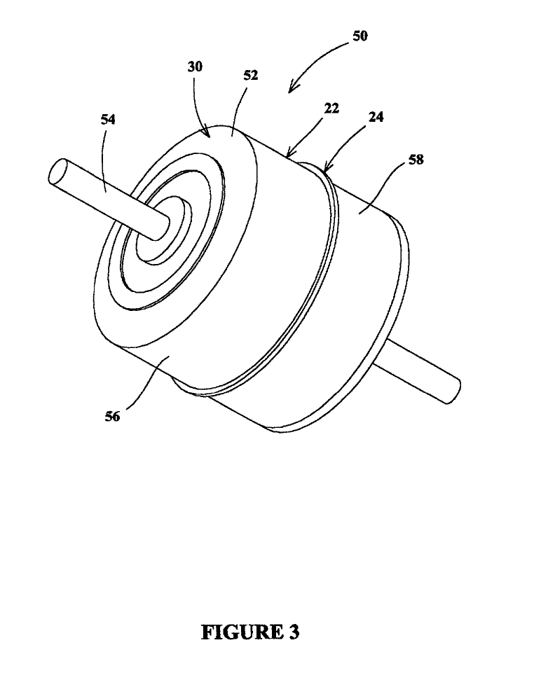

FIG. 3 is a perspective view of an inside-out motor 50 including flanged rotor cup 22 shown in FIG. 2. Rotor cup 22 includes annular flange 24 and top surface 30. Sidewall 26 extends to top surface 30 so that a top edge 52 is rounded. Inside-out motor 50 further includes a rotor shaft 54, a rotor 56, a stator (not shown), and a frame 58. Rotor shaft 54 is mounted on frame 58 which is attached to the stator such that rotor 56 rotates freely relative to the stator without contacting the stator. In one embodiment, rotor cup 22 is balanced to rotate without vibration. Annular flange 24 permits weights to be attached to flange 24 to achieve a desired level of rotor balance. In another embodiment, material is machined away from flange 24 to achieve a desired level of rotor balance.

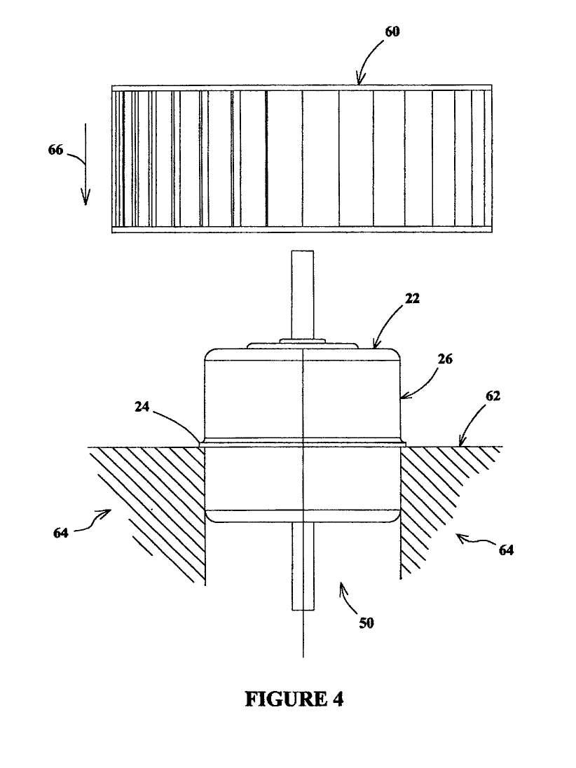

FIG. 4 is a side view of inside-out motor 50 shown in FIG. 3 positioned to be attached to a load 60. In one embodiment, load 60 is a fan. Inside-out motor annular flange 24 rests on a surface 62 of a tooling apparatus 64 while supporting rotor cup 22. Load 60 is pressed onto rotor cup 22 in a vertical direction 66. Annular flange 24 provides a smooth surface when load 60 is pressed onto rotor cup 22. Annular flange 24 has an increased surface area because of outwardly flared edge 37 (shown in FIG. 2).

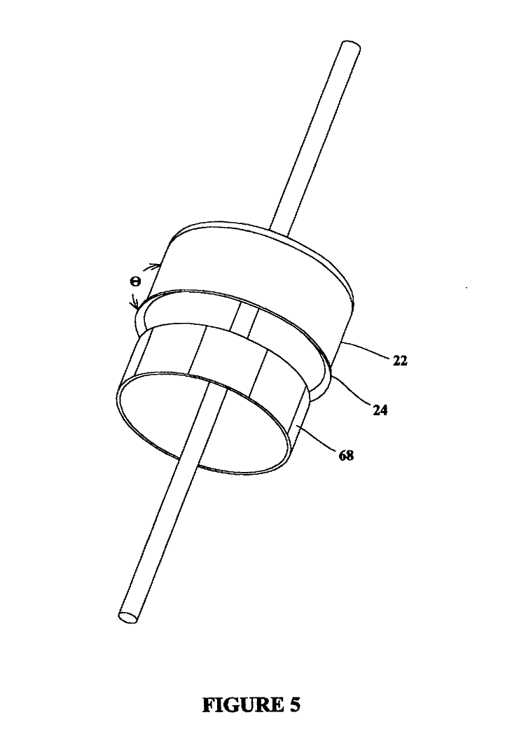

FIG. 5 is a perspective view of rotor cup 22 including annular flange 24 positioned to receive a magnet 68. Annular flange 24 is configured in a lead-in position to receive circumferential magnet 68. Annular flange 24 is outwardly flared by an angle φ and is tapered which assists to guide magnet 68 into rotor cup 22.

While the invention has been described in terms of various specific embodiments, those skilled in the art will recognize that the invention can be practiced with modification within the spirit and scope of the claims.

1. A method for fabricating a rotor cup, said method comprising the step of stamping the rotor cup frame and forming an annular flange surrounding an opening of the rotor cup.

2. A method in accordance with claim 1 wherein said method of fabricating a rotor cup further comprises the step of machining the rotor cup to reduce vibration in the rotor cup.

3. A method in accordance with claim 2 wherein said method of machining the rotor cup further comprises the step of machining the annular flange to facilitate a desired level of rotor balance.

4. A method in accordance with claim 1 wherein said method of fabricating a rotor cup further comprises the step of connecting a plurality of weights to the annular flange to facilitate a desired level of rotor balance.

5. A rotor cup assembly for an electric motor, said rotor cup assembly comprising a housing comprising a top, a bottom, a sidewall extending circumferentially from said top and having a first diameter, said sidewall and said top defining a cavity, and an annular flange extending circumferentially from said sidewall and having a first diameter, a second diameter, and a first thickness, said first diameter less than said second diameter.

6. A rotor cup assembly in accordance with claim 5 wherein said annular flange configured to have an edge, said edge outwardly flared from said sidewall by an angle φ.

7. A rotor cup assembly in accordance with claim 5 wherein said annular flange configured to receive a plurality of weights to facilitate a desired level of rotor balance.

8. A rotor cup assembly in accordance with claim 5 wherein said annular flange machined to remove material from said annular flange such that said annular flange configured to achieve a desired level of rotor balance.

9. A rotor cup assembly in accordance with claim 5 wherein said annular flange second diameter greater than said housing sidewall first diameter.

10. A rotor cup assembly in accordance with claim 5 wherein said annular flange provides a smooth surface for pressing an item into said rotor cup.

11. An electric motor comprising a stator including a stator core having a winding thereon, a rotor positioned at least partially around said stator, a rotor shaft positioned at least partially within said rotor, and a rotor cup, said rotor shaft extending through said rotor cup, said rotor cup comprising:
a housing comprising a top, a bottom, a sidewall, and an annular flange, said sidewall extending circumferentially from said top and having a first diameter, said annular flange extending circumferentially from said sidewall and having a first diameter, a second diameter, and a first thickness, said first diameter less than said second diameter.

12. An electric motor in accordance with claim 11 wherein said rotor cup top including an opening sized to accept said rotor shaft.

13. An electric motor in accordance with claim 11 wherein said rotor cup configured to receive a plurality of weights to facilitate a desired level of rotor balance.

14. An electric motor in accordance with claim 11 wherein said annular flange configured to be machined to remove material from said annular flange such that said annular flange achieves a desired level of rotor balance.

15. An electric motor in accordance with claim 11 wherein said annular flange second diameter greater than said housing sidewall first diameter.

16. An electric motor in accordance with claim 11 wherein said electric motor comprising an inside-out motor comprising an external rotor having magnetic elements mounted on said rotor and said stator located inside the magnetic elements.
